(19) United States
(12) Patent Application Publication
(10) Pub. No.: US 2010/0065697 A1
(43) Pub. Date: Mar. 18, 2010

(54) SIGN SUPPORT

(76) Inventor: Gordon Francis Howlett, Auckland (NZ)

Correspondence Address: HENRICKS SLAVIN AND HOLMES LLP;SUITE 200, 840 APOLLO STREET, EL SEGUNDO, CA, 90245, US

(21) Appl. No.: 12/516,802

(22) PCT Filed: Nov. 29, 2007
(86) PCT No.: PCT/NZ2007/000349

§ 371 Date: May 29, 2009

(51) Int. Cl. F16M 11/38

(52) U.S. Cl. 248/166

(57) ABSTRACT

The sign support (300) has a sign holder (2), of any suitable cross-section, accommodating a sign stand (501). A plurality, three being shown, of leg holders (3) are provided about the sign holder (2) each pivotally accommodating a respective leg (4). The legs (4) may be splayed outwardly to provide a support for the sign (500) and may also move vertically, indicated by arrows (A), in the leg holders (3) to accommodate an uneven ground surface. The legs (4) are able to nest together when in their collapsed position so as to minimise the height above ground of the sign support (300) in the event that the sign (500) is blown or knocked over.

The present invention relates to improvements in and relating to a sign support and more particularly but not exclusively to a support for a temporary road sign.

### BACKGROUND TO THE INVENTION

For simplicity the present invention will be described with reference solely to its use in respect of a temporary road sign, but it will be appreciated by those skilled in the engineering arts that various other uses could be found for the present invention including for example as a support for signs used in large retail stores, large buildings, car parks and the like.

To the present time various problems have been found with road signs which, when struck by a vehicle or blown over by winds, provide an inconvenient and frequently dangerous obstruction.

To that end, in New Zealand new traffic safety regulations have been proposed which will limit the height to which a road sign will extend after it has been knocked over. In the most recent proposal the requirements in New Zealand of Transit New Zealand will require that no road sign will stand higher than 150 mm above the ground when knocked over. At least similar regulations are likely to be existing, or could be proposed, in other countries. It will be appreciated that as temporary road signs are used extensively by roading contractors or the traffic police and the like, the inconvenience and potential danger of knocked over signs can represent a substantial problem.

It is therefore an object of the present invention to provide a sign support and/or a method of providing a sign support which will overcome or at least obviate problems at the present time or which at least will provide the public with a useful choice. Further objects of this invention in its various embodiments will become apparent from the following description.

### BRIEF SUMMARY OF THE INVENTION

According to one aspect of the present invention there is provided a sign support including a sign holding means and a plurality of leg holding means positioned about the sign holding means, each leg holding means being adapted to pivotally receive a respective leg which is able to pivot between a first position providing a support for a sign stand, supported in use in the sign holding means, and a second position in which, with the sign collapsed, a plurality of the legs are able to substantially nest together in order to minimise the height of the collapsed sign.

According to a second aspect of the present invention a method of providing a sign support includes:
a. Providing a sign holding means adapted to accommodate in use a sign stand and maintain it in a substantially vertical position;
b. Providing a plurality of leg holding means about said sign holding means with each leg holding means being adapted to pivotally accommodate a respective leg;
c. Adapting each of the legs so that in a collapsed condition of the sign, the legs are able to substantially nest together in order to minimise the height of the collapsed sign.

Preferably, the sign support and/or method as above defined provides for a portion of each leg to be slideable within a respective leg holding means to facilitate the accommodation of an uneven support surface.

According to a still further aspect of the present invention there is provided a sign support and/or method of providing a sign support substantially as herein described with reference to the accompanying drawings.

Further aspects of this invention, which should be considered in all its novel aspects, will become apparent from the following description given by way of example of possible embodiments and with reference made to the accompanying drawings.

### BRIEF DESCRIPTION OF THE DRAWINGS

FIG. 1: Shows very diagrammatically and in part exploded view, a sign support according to one possible embodiment of the invention;

FIG. 2: Shows a plan view of the sign support of FIG. 1;

FIG. 3: Shows a side view of the sign support of FIG. 1 with its legs nested together;

FIG. 4: Shows in an exploded form the components of the sign support of FIG. 1;

FIG. 5: Shows diagrammatically a plan view of the sign support of FIG. 1 with its legs ready to be nested together;

FIG. 6: Shows very diagrammatically a plan view of a sign support according to a second possible embodiment of the invention with its legs in their extended position;

FIG. 7: Shows a side view of the embodiment of FIG. 6 with the legs nested together;

FIG. 8: Shows an end view of the embodiment of FIG. 6 with its legs in their nested position;

FIG. 9: Shows very diagrammatically a partial plan view of a third possible embodiment to the invention with its legs in their extended position;

FIG. 10; Shows an end view of the embodiment of FIG. 9;

FIG. 11; Shows very diagrammatically a plan view of a fourth possible embodiment of the invention with its legs extended;

FIG. 12: Shows a side view of FIG. 11 with the legs nested together;

FIG. 13; Shows an end view of FIG. 11 with the legs nested together;

FIG. 14; Shows very diagrammatically a partial plan view of a sign support according to a fifth possible embodiment of the invention;

FIG. 15; Shows an end view of FIG. 14;

FIGS. 16, 17, 18, and 19; Show diagrammatically plan perspective views of the sign support according to the second to fifth embodiments of the previous figures;

FIG. 20; Shows very diagrammatically by way of example only the sign support of FIG. 19 in use supporting a temporary road sign; and

FIG. 21; Shows very diagrammatically an exploded view of the sign support of FIG. 19 with the bottom end of a cylindrical stand positioned ready for insertion into, or removal from, the sign support.

### BRIEF DESCRIPTION OF POSSIBLE EMBODIMENTS

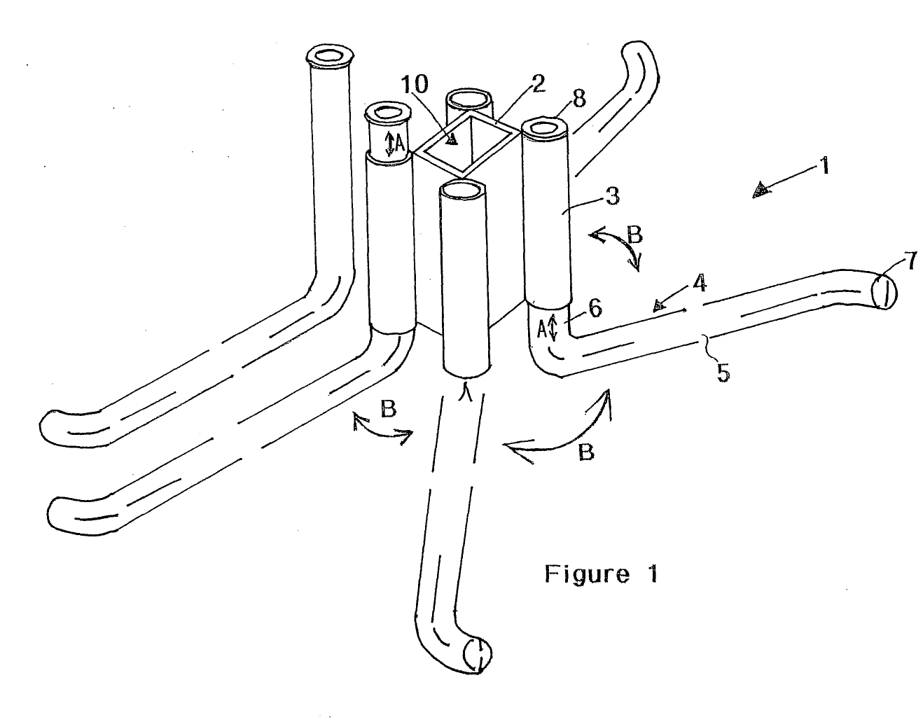

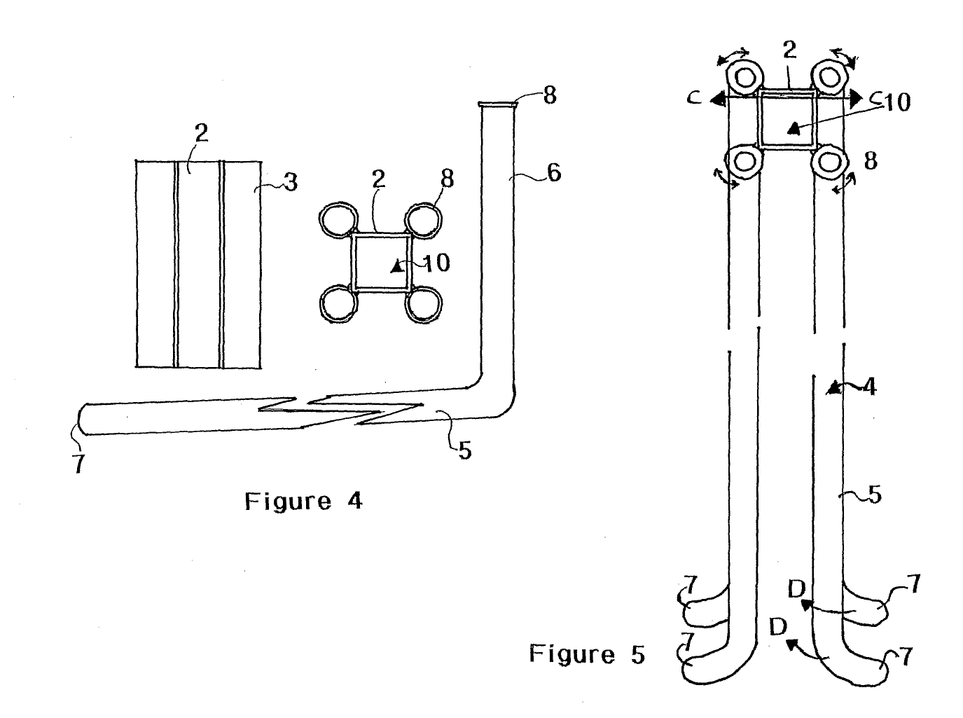

Referring firstly to FIGS. 1 to 5 of the accompanying drawings the sign support according to one possible embodiment of the invention is referenced generally by arrow 1. It is shown having in this embodiment a substantially central sign holding means 2. In this embodiment the holding means 2 is shown of a square or rectangular cross-section defining a substantially square or rectangular hollow interior and adapted to accommodate a square or rectangular stand at the top end of which would be the road sign or the like. Alternatively the holding means 2 could be of any suitable cross-section such as a circular cross-section adapted to accommodate a correspondingly circular stand.

The holding means 2 is shown with a plurality of leg holding means 3. In the example shown there are four leg holding means 3 which are each in a form of a substantially circular tube. Typically in the case of a metal construction, a tube 3 would be welded at each of the corners of the holding means 2. An integral moulding or casting of any suitable material could however be used as one alternative.

Each of the leg holding means 3 is shown adapted to accommodate an upper portion 6 of a leg referenced generally by arrow 4. Preferably each leg portion 6 is adapted to be slideable in the direction indicated by arrows A within the leg holding means 3. A flange 8 or the like may provide an abutment for the top of the leg portion 6 so as to prevent the escape of the leg 4 from the leg holding means 3. At the lower end of the leg portion 6 the leg portion 5 is shown extending outwardly to an end portion 7. Preferably the included angle between the leg portions 5 and 6 is not a right angle but is an obtuse angle so as to raise the sign holding means 2 spaced apart above the ground. Also as shown, in a preferred embodiment the ends 7 of the legs 4 may be curved, such as bent or folded, so as to avoid the leg ends catching on an obstruction as the sign support 1 moves to a collapsed position.

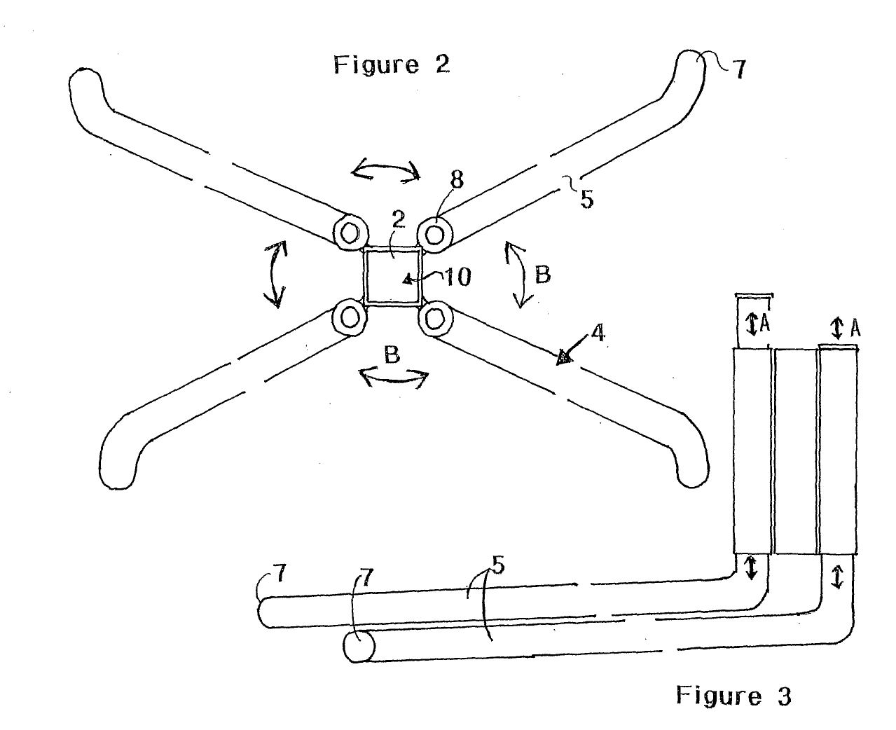

In FIGS. 1 and 2 the legs 4 are shown splayed outwardly so as to provide support for a sign (not shown) held in a vertical position by the sign holding means 2. As the legs 4 are pivotally mounted in the leg holding means 3 they can be pivoted outwardly as required to provide this support. The term “pivot” is used to describe any suitable rotatable or movable connection and would include a hinge or the like. By means of the ability of the leg portion 6 to slide within the leg holding means 3, uneven ground can be accommodated as the leg portions 6 are able to slide up and down as required.

In the event that the road sign is collapsed intentionally or unintentionally, the latter such as by being struck by a vehicle or blown over by high winds, then as seen in FIG. 5, the legs 4 are able to pivot or hinge and slide and nest together. In this way with the sign support 1 on its side the maximum height above the ground would be that indicated between arrows C in FIG. 5, the top legs 4 (on the right side as shown in FIG. 5) folding downwardly as indicated by the arrows D to be positioned with the lower legs.

In order to comply with local or government rules or regulations the distance “C” can therefore be ensured so as to be within the statutory or regulatory requirements such as for example no more than 150 mm above the ground.

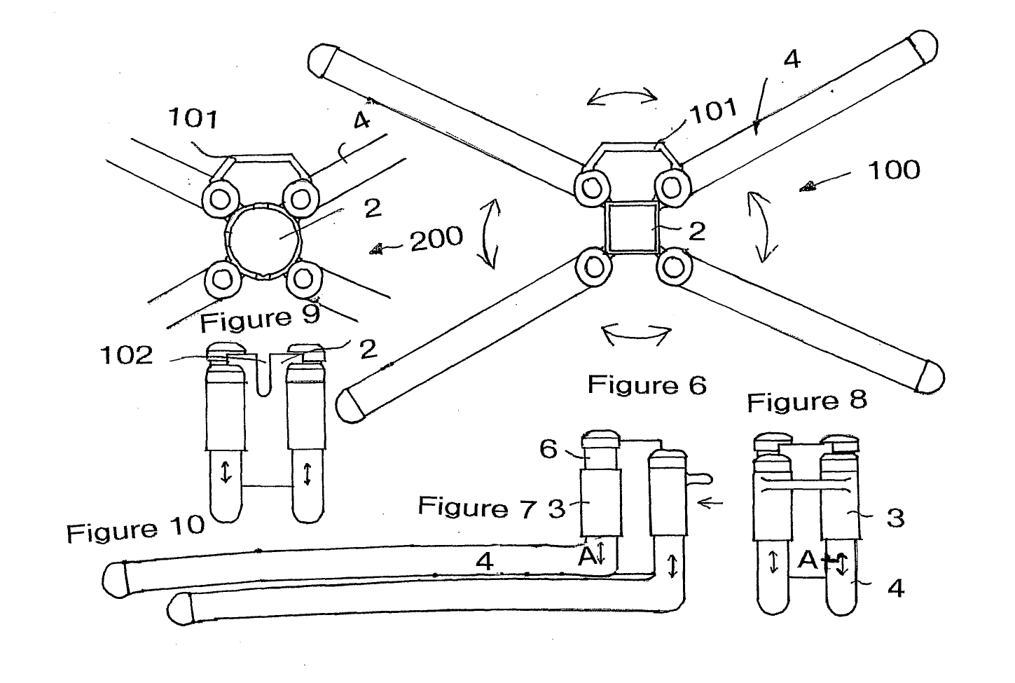

Turning now to FIGS. 6, 7 and 8 a second possible embodiment of the invention is shown referenced generally by arrow 100. This is shown with a substantially square holding means 2 and four legs 4 pivotably moveable as indicated by the arrows within respective holding means 3. The holding means 3 are shown in this embodiment as being substantially shorter than those of the embodiment of FIG. 1 which, depending on other design criteria, may affect the amount of vertical movement available for the leg portion 6 of each leg in the leg holder 3 in the direction indicated by arrows A. In this embodiment a handle 101 is shown provided extending between a pair of the leg holders 3 to assist in the portability of the sign support 100.

Referring then to FIGS. 9 and 10 in a third possible embodiment of the invention, referenced generally by arrow 200, the holding means 2 is in this embodiment is substantially cylindrical and provided with four legs 4 and a handle 101. It would be appreciated that with a cylindrical holding means 2 it would necessary to provide some manner of controlling the rotation of a tubular sign stand or the like (not shown) which will be inserted into the holding means 2. As shown particularly in FIG. 10 the holding means 2 may therefore be provided with at least one (four being shown) vertical slots 102 into which a pin or projection or the like of a sign stand (not shown) can be located in use which will act to prevent the rotation of the sign stand and its sign in the holder 2.

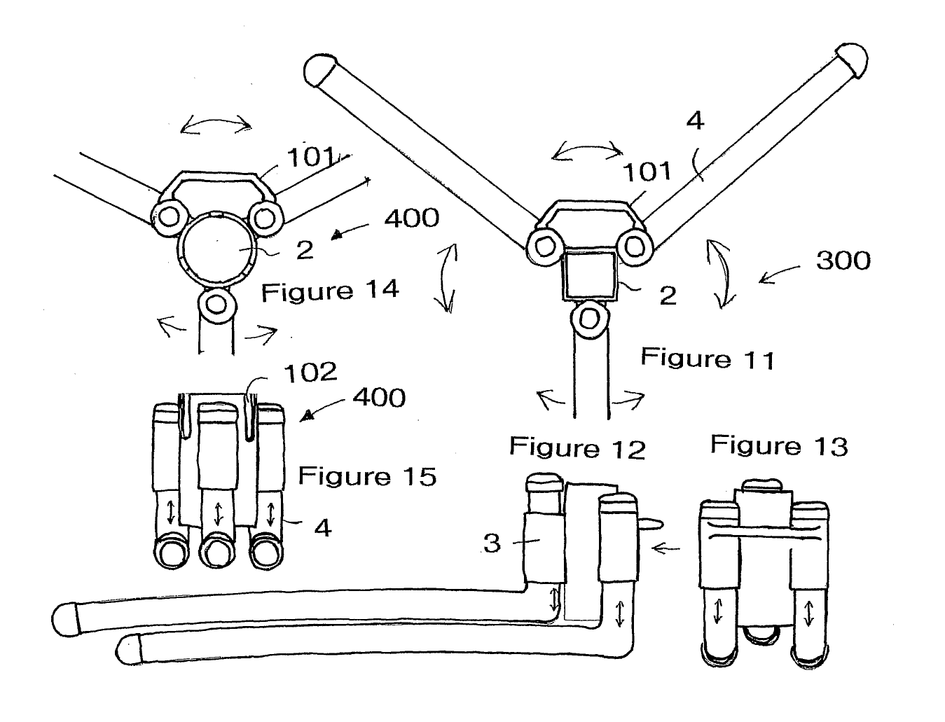

Turning now to FIGS. 11 to 13 a further embodiment of the invention is shown referenced generally by arrow 300. The sign support 300 is shown with three legs 4 mounted in respective holding means 3 mounted about a substantially square holding means 2. A handle 101 is again provided to assist in the portability of the sign support 300.

Referring then to FIGS. 14 and 15, this embodiment referenced generally by arrow 400 is essentially similar to the embodiment of FIGS. 9 and 10 being provided with a substantially cylindrical holding means 2 and with substantially vertical slots 102 and a handle 101, but with only three legs 4.

In FIG. 15 the sign support 400 is shown with its three legs 4 all in their folded or collapsed condition and nested relative with one another so as to minimise the height of a collapsed sign support 400 above the ground.

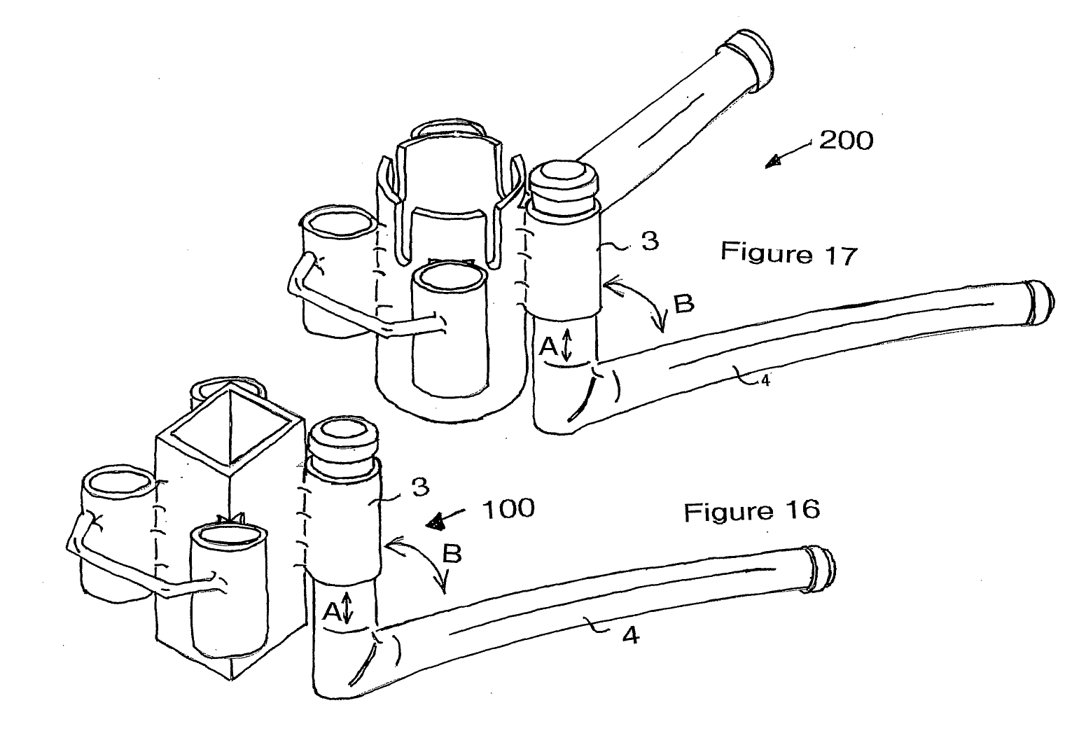

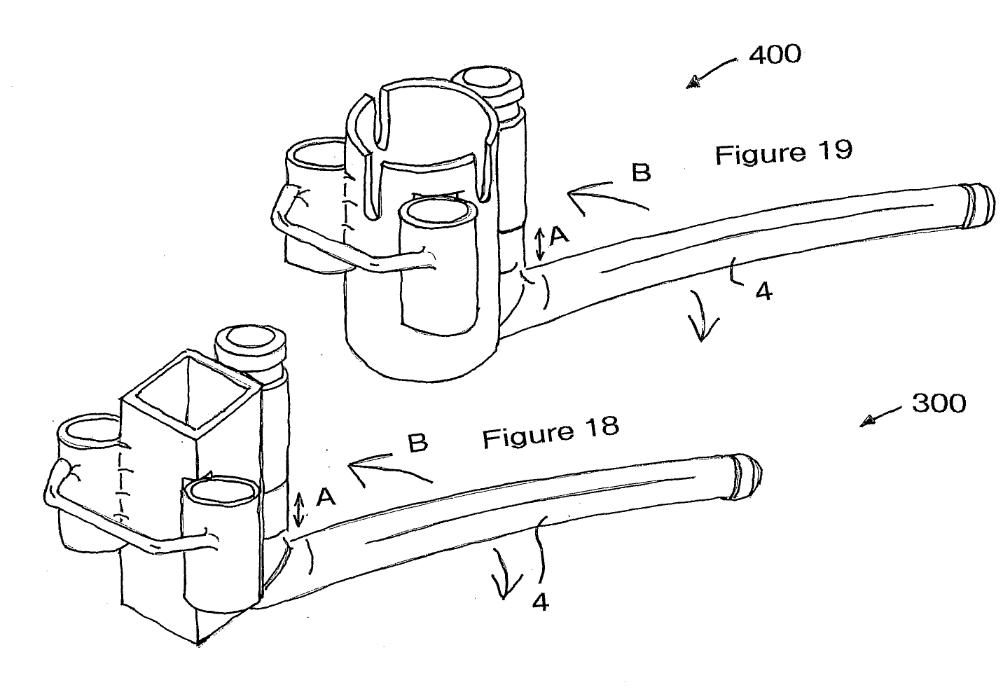

Referring now to FIGS. 16, 17, 18 and 19 the respective sign supports 100, 200, 300 and 400 are each shown in respective plan perspective views with a leg 4 mounted in a respective holder 3 and able to slide vertically relative to the holder in the direction of the arrows A and able to rotate substantially horizontally about the holder 3 in the direction indicated by arrows B.

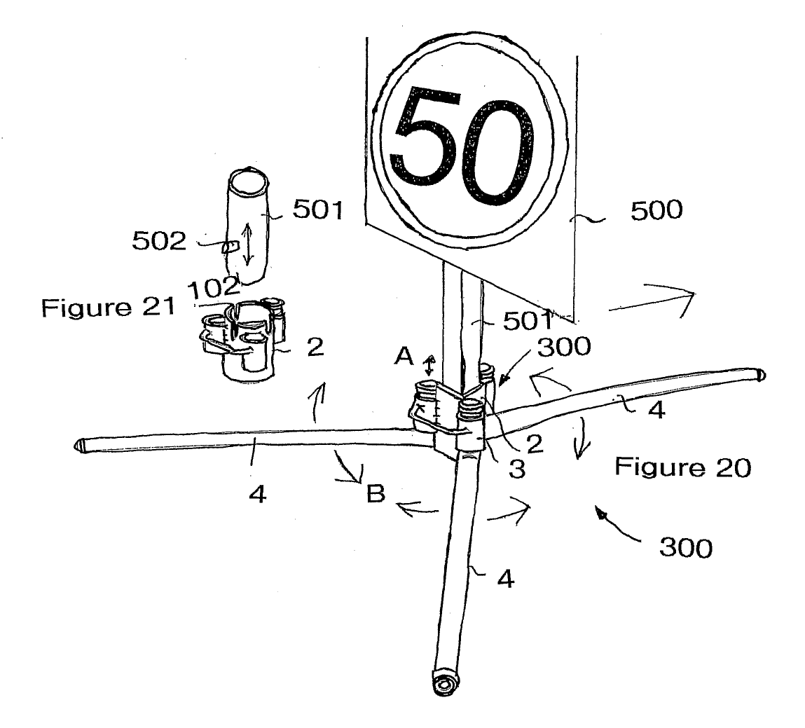

Turning then to FIG. 20, by way of example only, the sign support 300, previously shown in FIGS. 11, 12, 13 and 18, has its three legs 4 splayed outwardly to provide the support for a temporary road sign 500 provided at the upper end of a stand 501. In this embodiment the holding means 2 is a substantially square or rectangular cross section into which the stand 501 of commensurate cross section can be accommodated and held against rotation.

In FIG. 21 however an alternative, substantially cylindrical, holding means 2 is shown provided with a plurality of substantially vertical slots 102 into which can be accommodated a pin or the like 502 of a substantially cylindrical stand 501 in order to prevent the stand and its supported sign from rotating.

Where in the foregoing description, reference has been made to specific components or integers of the invention having known equivalents, then such equivalents are herein incorporated as if individually set forth.

Although this invention has been described by way of example and with reference to possible embodiments thereof, it is to be understood that modifications or improvements may be made thereto without departing from the scope of the invention as defined in the appended claims.

1. A sign support including a sign holding means and a plurality of leg holding means positioned about the sign holding means, each leg holding means being adapted to pivotally receive a respective leg which is able to pivot between a first position providing a support for a sign, supported in use in the sign holding means, and a second position in which, with the sign collapsed, a plurality of the legs are able to substantially nest together in order to minimise the height of the collapsed sign, and wherein each leg includes an upper portion adapted to be accommodated within a respective leg holding means and a lower portion extending outwardly to an end portion, the upper portion of each said leg being able to slide substantially vertically, in use, within a respective leg holding means so as to facilitate use of the sign support on uneven ground.

2. A sign support as claimed in claim 1 in which at least three leg holding means are positioned spaced apart about the sign holding means.

3. A sign support as claimed in claim 2 in which four leg holding means are provided about the sign holding means.

4. A sign support as claimed in claim 3 in which the sign holding means is of a substantially square or rectangular cross section and one of said leg holding means is provided at each corner of said sign holding means.

5. A sign support as claimed in any one of claims 1 to 3 in which the sign holding means is of a substantially cylindrical cross section.

6. A sign support as claimed in claim 5 which the sign holding means includes at least one substantially vertical slot adapted in use to accommodate a projection provided for a sign stand to prevent it rotating within the sign holding means.

7. A sign support as claimed in claim 1 in which a top of each upper portion is provided with an abutment means to prevent the escape of the upper portion from the leg holding means.

8. A sign support as claimed in claim 1 wherein each leg holding means is of lesser length than the sign holding means.

9. A sign support as claimed in claim 1 in which an included angle between the leg upper portion and the leg lower portion is obtuse so as, in use, to raise the sign holding means spaced apart above the ground.

10. A sign support as claimed in claim 1 in which the leg end portion is curved so, in use, to avoid the end portion catching on an obstruction as the sign support moves to a collapsed position.

11. A method of providing a sign support including:
a. providing a sign holding means adapted to accommodate in use a sign stand and maintain it in a substantially vertical position,
b. providing a plurality of leg holding means about said sign holding means with each leg holding means being adapted to pivotally accommodate a respective leg;
c. adapting each of the legs so that in a collapsed condition of the sign, the legs are able to substantially nest together in order to minimise the height taken by the collapsed sign;
d. providing each leg with an upper portion able to slide substantially vertically, in use, within a respective leg holding means so as to facilitate use of the sign support on uneven ground.

12. (canceled)
